(19) United States
(12) Patent Application Publication
(10) Pub. No.: US 2025/0222965 A1
(43) Pub. Date: Jul. 10, 2025

(54) CONTAINER TRANSPORTATION DEVICE

(71) Applicant: David Czajkowski, Myakka City, FL (US)

(72) Inventor: David Czajkowski, Myakka City, FL (US)

(21) Appl. No.: 18/750,524

(22) Filed: Jun. 21, 2024

Related U.S. Application Data
(60) Provisional application No. 63/618,874, filed on Jan. 8, 2024.

(51) Int. Cl. B62B 1/06; A01K 39/02; B62B 1/04

(52) U.S. Cl. CPC B62B 1/06; A01K 39/02; B62B 1/04; B62B 2202/028; B62B 2203/10; B62B 2203/20

(57) ABSTRACT

A container transportation device is disclosed, including a lower frame assembly including an arc-shaped bar positioned between a first axle and a second axle. A first wheel is mounted to the first axle and a second wheel is mounted to the second axle. An upper frame includes a vertical spine connected to the lower frame assembly at the base of the upper frame. The vertical spine extends between the base and a handle positioned at the top of the vertical spine. A lifting arm extends from the vertical spine to receive and support a container to enable the transportation of the container.

### CROSS-REFERENCE TO RELATED APPLICATIONS

The present application claims priority to U.S. Provisional Application No. 63/618,874 filed Jan. 8, 2024, titled “POULTRY WATERER CART,” which is hereby incorporated by reference in its entirety.

### TECHNICAL FIELD

The embodiments disclosed herein generally relate to devices used when lifting and carrying containers by their handles.

### BACKGROUND

Devices exist which aid in carrying and transporting various items. In particular, carts are wheeled apparatuses which have a means of supporting an item and transporting the item between locations. Carts provide an efficient and easy means of transporting items which would otherwise be difficult or impossible to carry. For example, buckets containing various materials can be heavy and difficult to carry. While devices exist which can hold and transport buckets, they often require an individual to lift the bucket onto a surface of the cart. Further, many existing designs do not provide a means of leveling the bucket during movement over uneven surfaces.

In one example, a poultry waterer is a device that holds a trough of water in which poultry drink from. The poultry waterer is preferably designed so that it is not easily tipped over by the poultry, as well as to ensure that dirt and debris cannot easily enter the trough and container. In such, key elements preferable to poultry waterers is one that is not susceptible to being soiled or spilled, while being simple for the poultry to drink from.

Many poultry waterer configurations are currently available. While each poultry waterer varies in their mechanism and style, they are all trying to achieve the same goal, giving poultry access to fresh water with ease, while keeping chances of the vessel being spilt as low as possible.

Bell poultry waterers are perhaps the most commonplace poultry waterers, as they are generally inexpensive and generally do a good job of giving poultry easy access to fresh water, whilst keeping spillage to a minimum. These poultry waterers are available in both plastic and metal and get their name as they are shaped like a bell, with a trough around the bottom for poultry to sip from. This style is manually filled and is gravity fed such that the more the poultry drinks, the more water will be dispensed into the trough. A key feature of bell poultry waterers is that they can be easily hung up by a handle at the top of the bell.

Bell poultry waterers can hold several gallons of water, which can make them quite heavy when full. Additionally, the bottom of the bell can have a rather large diameter. Between the large diameter and the heavy weight of the filled bell, transporting a poultry waterer from the water source to a poultry coop can be awkward and challenging if one is attempting to carry the waterer by the handle. Furthermore, if the waterer is spilled during transportation, the waterer will need to be refilled.

Utilizing traditional two wheel moving carts to transport poultry waterers is not effective, where the poultry waterer would be placed on the nose plate, because when the cart is tilted back the poultry waterer would not be level and the water in the poultry waterer would spill out the bottom of the bell. Furthermore, transporting a poultry waterer on a flat cart is not ideal due to spillage, the waterers need to swing freely like a pendulum to reduce spillage and loss of water.

What is needed is an apparatus which makes it easier to transport a heavy poultry waterer filled with water. Furthermore, the apparatus should keep the poultry waterer level and stable during transportation, to minimize spillage, and allow the waterer to swing freely to compensate for uneven ground.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a container transportation device, including a lower frame assembly including an arc-shaped bar positioned between a first axle and a second axle. A first wheel is mounted to the first axle and a second wheel is mounted to the second axle. An upper frame includes a vertical spine connected to the lower frame assembly at the base of the upper frame. The vertical spine extends between the base and a handle positioned at the top of the vertical spine. A lifting arm extends from the vertical spine to receive and support a container to enable the transportation of the container using the container's handle.

The present embodiments aim to solve the aforementioned issues with transportation of poultry waterers by providing a cart device specifically designed for the transport of poultry waterers. However, the embodiments may also be utilized to carry and transport various forms of containers.

The device is a two-wheeled cart with an arm with a removeable hook and an open bottom. The container can be lifted and carried by the hook using the handle on the top of the container, keeping the container suspended above the ground. When the cart is tilted backwards or forwards, the container will remain level. Additionally, the device can be tipped forward and backward to scoop the container up by the handle so that you do not need to lift the container by hand.

The design of the device with the arm and hook and the open bottom provides a solution for effective and ergonomic transportation of the container which cannot be achieved with the current solutions available.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

In one aspect, the device includes a swing backstop to prevent the container from excessively swinging.

In one aspect, the swing backstop is connected to the upper frame via a lateral member to extend the swing backstop in front of the upper frame.

In one aspect, the device includes a grip removably engaged with the handle.

In one aspect, a top of the upper frame includes a curved portion to increase leverage.

In one aspect, the lifting arm includes a hook positioned at an end of the lifting arm, wherein the hook retains a carrying handle of the container.

In one aspect, the hook enables the container to hang by the carrying handle and pivot to facilitate the pick-up, transport, and set down of the container.

It is to be understood that while the device is described for use as a poultry waterer transportation device, the device can be used to carry various containers. For example, the device may be used to carry buckets or other containers filled with various fluids, solids, etc. In another example, the device may be used to carry agricultural products such as feed, water, fertilizer, or other chemicals. In another example, the device may be employed for use in an industrial setting where large containers of chemicals are commonly transported and dispensed.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a side elevation view of the container transportation device, according to some embodiments;

FIG. 2 illustrates a perspective view of the container transportation device carrying a container, according to some embodiments;

FIG. 3 illustrates an exploded view of the container transportation device, according to some embodiments;

FIG. 4 illustrates a perspective view of container transportation device, according to some embodiments;

FIG. 5 illustrates a front view of container transportation device, according to some embodiments;

FIG. 6 illustrates a rear view of the container transportation device, according to some embodiments;

FIG. 7 illustrates a perspective view of container transportation device with the poultry waterer installed, according to some embodiments;

FIG. 8 illustrates a side view of the container transportation device with the poultry waterer installed, according to some embodiments;

FIG. 9 illustrates a perspective view of the container transportation device with the poultry waterer installed, according to some embodiments;

FIG. 10 illustrates a perspective view of the container transportation device in a folded configuration, according to some embodiments; and

FIG. 11 illustrates a perspective view of the container transportation device in a folded configuration, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a container transportation device used for carrying agricultural and/or industrial containers using their existing handles over smooth or uneven surfaces while preventing the container from tilting, and thus spilling the contents of the container. The container transportation device is designed to pick up, transport, and set down the containers which are often heavy, thus eliminating the need for a user to lift the container during its transport.

The container transportation device (which may be referred to herein simply as “device” or “the device”) includes two wheels rotatably mounted to independent axles connected to a tubular frame. The frame may be constructed of steel, aluminum, or another sufficiently rigid material. A handle provides leverage and is connected to a lifting arm attached at a swivel point. The lifting arm includes a hook at a second end and may be held in position by a support arm. The support arm may include multiple positions that can be changed via removable pins.

In some embodiments, the device may be easily and efficiently assembled and disassembled. Disassembly of the device may facilitate efficient shipping by reducing the space required to package and ship the device. Prior to use, the operator may then easily reconfigure the device to its in-use configuration as illustrated and described herein. In such, the device may be configured to allow its components to lie flat in a box for storage, during shipping, etc.

In some embodiments, the device may be constructed of any suitable material which provides a supportive and durable frame. For example, the device may be constructed of metal, rigid plastics, composites, etc.

The device enables the container to be easily picked up, transported and set down. The container may include handles (as is common in the arts), which enable the engagement of the container with the device.

In some embodiments, the device allows operators to transport the container over variable terrain and uneven surfaces by allowing the container to swing like a pendulum which enables the container to self-level, thus preventing spillage.

In some embodiments, the device includes large tires capable of rolling over variable and uneven terrain. The tires may be configured such that they may easily roll over “off road” surfaces (i.e., dirt, gravel, mud, sand, rocks, grass, etc.).

In some embodiments, the adjustable lifting arm enables the device to pick up, transport and set down containers of various sizes, shapes, and configurations using the existing handles on the container. In such, the device provides a universal solution for picking up, transporting and setting down various containers.

In some embodiments, the device may be useful for transporting containers holding substances such as paint, tar, chemicals, water, oil, food, tractor fluid, fertilizer, etc. While the embodiments often describe the use-case of poultry watering, it is to be understood that the device may be used for transporting various substances including liquids and solids.

In some embodiments, the shape and radius of the handle allows the device to be rotated forward to pick up the container without having to overextend the operators arm as well as lowering the handle in a way that the handle can raise the container without the handle being uncomfortably low during transport of the container.

The device functions by an operator (otherwise referred to as “the user”) using one hand on the handle. The operator pushes the cart in line with the desired container then rotates the handle forward which lowers the hook under the containers lifting handle. The operator then uses the hook to scoop up the container with the hook by lowering the carts handle and lifting the container. The operator can now push the cart over uneven terrain utilizing the oversized wheels. The hook supports the container centered over the open bottom of the cart allowing the container to self-level and swing freely like a pendulum to prevent spillage. When you reach your destination just reverse the steps to gently set down the contents. If the hook is too high or too low to comfortably pick up the container you simply raise or lower the lifting arm by removing quick pins from the support arm and changing the position.

In some embodiments, the hook is removable to allow the user to select from various hook configurations which may best carry a particular container. Further, the hook may simply be removed when it is not needed.

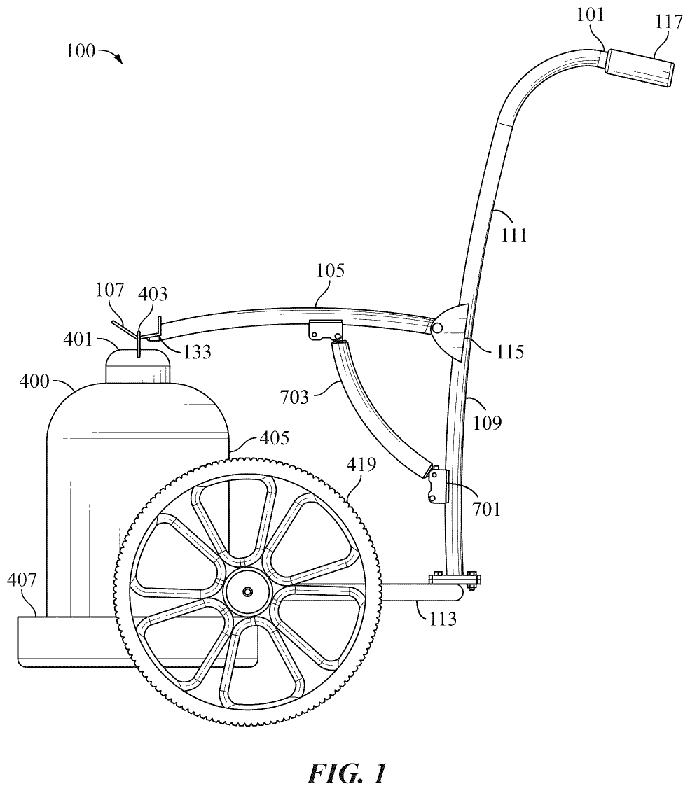

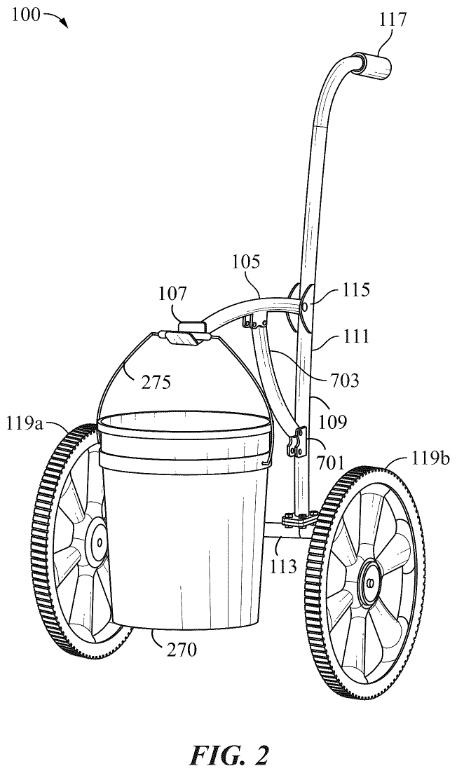

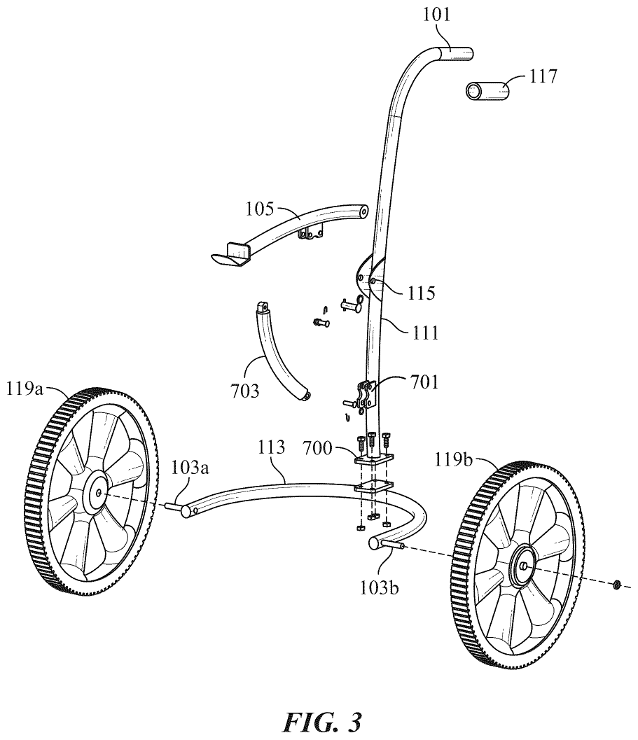

FIG. 1 and FIG. 2 illustrate the container transportation device 100. The device 100 includes a handle 101, first and second axles 103a,103b (see FIG. 3), a lifting arm 105, a support arm 703, having a hook 107, and a vertical spine 109. The handle 101 is connected to an upper frame 111 and allows the user to easily control the device 100 during transportation of the container. The upper frame 111 is positioned between the handle 101 and a lower frame assembly 113. The upper frame 111 is comprised of the vertical spine 109 and includes a bracket 115 to pivotally engage with the lifting arm 105. One skilled in the arts will readily understand that while a bracket 115 is described as a means for connecting the upper frame 111 to the lifting arm 105. A first wheel 119a is rotatably mounted to the first axle 103a and a second wheel 119b is rotatably mounted to the second axle 103b.

In some embodiments, the lifting arm 105 includes means of adjustment, such as by pivoting the lifting arm at a bracket to allow the user to raise and/or lower the container being held by the lifting arm.

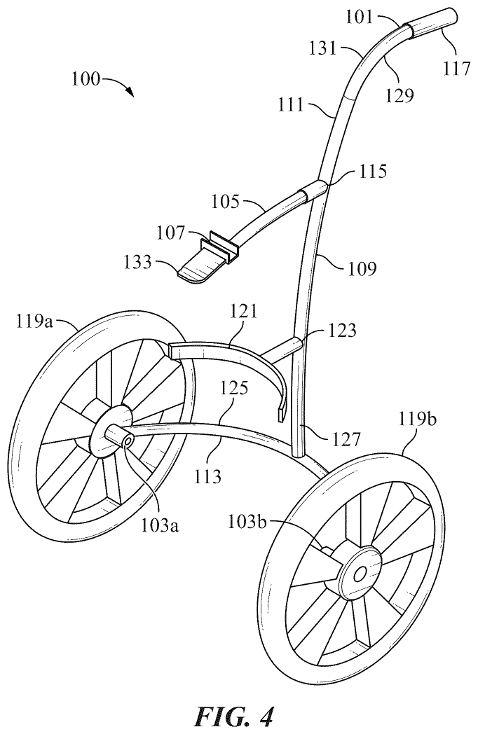

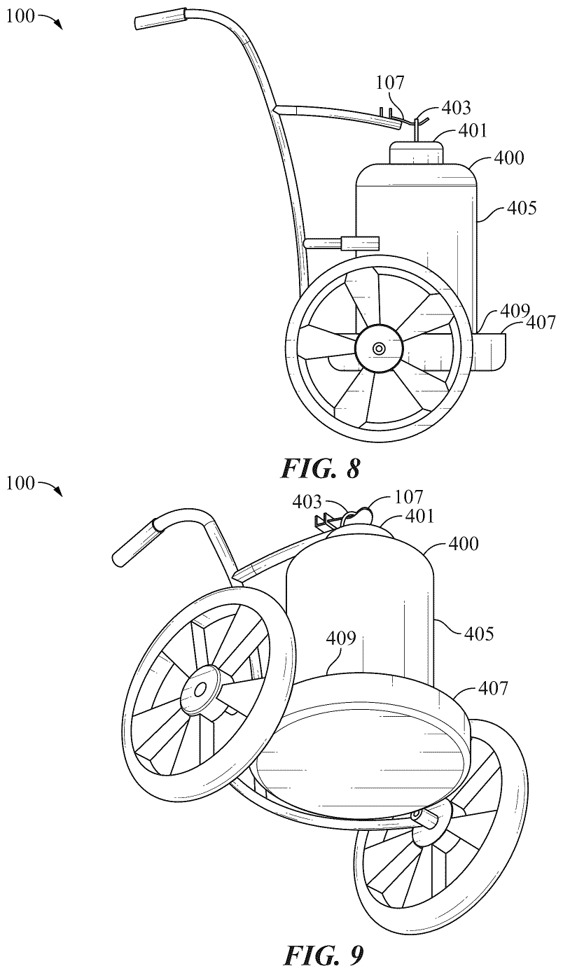

In some embodiments, the lifting arm 105 is a rigid lifting arm (as illustrated in FIGS. 4-9) which is mounted in a fixed position to the vertical spine 109.

In particular, FIG. 2 illustrates the device 100 carrying a container which is illustrated as a bucket 270. The bucket handle 275 is attached to the hook 107 which enables the bucket 270 to hang therefrom. The exemplary drawing shows a wire-style handle common on many buckets. However, it should be understood that containers may have various handle configurations, and in such, the hook 107 allows for the user to select a suitable hook configuration for each container.

FIG. 3 illustrates an exploded view of the device 100 components to illustrate how the device may be deconstructed and reconfigured. The wheels 119a, 119b disconnect from the axles 103a, 103b to enable their replacement and/or disconnection and reconnection when assembling and disassembling the device 100. The wheels 119a, 119b may be secured to the axles 103a, 103b using threaded bolts, pins, or other connection means. The lower frame assembly 113 releasably connects to the upper frame 111 via a mounting bracket 700 using a plurality of bolts to secure the components together. The adjustable support arm 703 releasably connects via a pivot bracket 701 to the upper frame 101. The adjustable support arm 703 may also connect to an adjustable lifting arm 105 which allows the user to adjust the height and angle of the adjustable lifting arm 105 when picking up, transporting, and setting down the poultry waterer or other container. The grip 117 may disconnect from the handle 101 to allow the user to replace the grip as needed.

In some embodiments, the mounting bracket 700 may pivot to allow the device 100 to fold during storage, shipping, etc. In such, the vertical spine 109 will fold at the mounting bracket 700 to flatten the device 100. A locking mechanism may be provided to enable the user to selective lock the device in the folded or upright configurations.

FIGS. 4-9 illustrate an alternative embodiment of the container transportation device 100. The teaching of the below embodiments may be applied to FIGS. 1-3 above and one or more elements may be removed or replaced without deterring from the embodiments described herein.

FIG. 4 illustrates the device 100 without the container. The device 100 includes a handle 101, first and second axles 103a, 103b, a rigid lifting arm 105 having a hook 107, and a vertical spine 109. The device 100 may also include a swing backstop. The handle 101 is connected to an upper frame 111 and allows the user to easily control the device 100 during transportation of the container. The upper frame 111 is positioned between the handle 101 and a lower frame assembly 113. The upper frame 111 is comprised of the vertical spine 109 and includes a bracket 115 to pivotally engage with the rigid lifting arm 105. One skilled in the arts will readily understand that while a bracket 115 is described as a means for connecting the upper frame 111 to the rigid lifting arm 105, other means of coupling the rigid lifting arm 105 to the upper frame 111 may be implemented. A first wheel 119a is rotatably mounted to the first axle 103a and a second wheel 119b is rotatably mounted to the second axle 103b.

In some embodiments, a swing backstop 121 is optionally provided and functions to reduce backswing of the container during transport. The swing backstop 121 is connected to the upper frame 111 via a lateral member 123 to extend the swing backstop 121 forward such that it may contact the container.

The handle 101 is at the very top of the device 100, connected to the vertical spine of the device. The handle 101 is curved, to provide the user more leverage, and has a grip 117 which provides a comfortable means of gripping the handle 101.

The axles 103a, 103b are connected to two wheels 119a, 119b, connected by an arc-shaped bar 125, or other suitable shape rather than an arc-shape (e.g., a rectangular shape, or similar shape which may allow for the wheels to be connected to the axles) which is a component of the lower frame assembly 113. The wheels 119a,119b have a large diameter to accommodate uneven surfaces typically found on a farm or in an agricultural setting. The arc-shape of the bar 125 allows the larger diameter of the trough of the poultry waterer to hang between the two wheels 119a, 119b, to keep the center of gravity low to the ground and keep the device 100 more compact.

In some embodiments, the arc-shaped bar 125 may not necessarily be arc-shaped but may be configured to avoid being contacted by the container being carried, while being shaped to connect to the wheels via the axles (i.e., a rectangular-shaped bar, etc.).

The vertical spine 119 connects the handle 101 to the lower frame assembly 113. The base 127 of the vertical spine 119 attaches to the lower frame assembly 113 at the midpoint of the arc-shaped bar 125 and the top 129 of the upper frame 111 (and vertical spine 109) terminates into the handle 101. The vertical spine 119 makes a curved elbow shape at the top of the vertical spine 119 before it terminates into the handle 101.

In some embodiments, the adjustable lifting arm 105 with the hook 107 at an end 133 of the adjustable lifting arm 105 is attached is connected to the vertical spine 109 below the curved portion 131 of the upper frame 111. The lifting arm 105 with a hook 107 protrudes from the vertical spine 109 so that the hook 107 is aligned with the center point of the arc, just beyond the center of the wheels. The lifting arm 105 with a hook 107 provides a secure connection point to hang a container by its handle.

In some embodiments, the hook 107 may be removably connected to the adjustable lifting arm 105.

There is an optional swing backstop 121 attached to the vertical spine 109 between the connection points on the vertical spine 109 for the axle and the for the arm with a hook 107. The swing backstop 121 is arc shaped and is connected to the vertical spine 109 by a lateral member 123 that extends the center of the arc to approximately the midpoint between the two wheels. The swing backstop functions to physically prevent a hanging poultry waterer from swinging with too much travel during transportation.

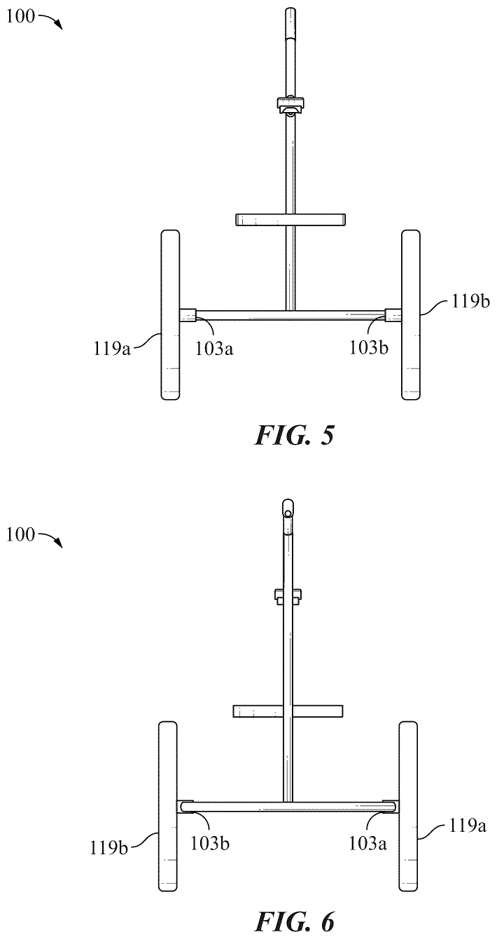

FIG. 5 and FIG. 6 illustrate front and rear elevation views of the device 100. Wheels 119a, 119b are provided having a sufficient wheel height to provide clearance from their mounting point (i.e., axles 103a,103b). This allows for the container to be raised above the ground surface and for efficient transport over uneven, off-road surfaces. The tires may be rubber inflatable tires, plastic tires, or constructed of another suitable material such that the tires can withstand repeated use.

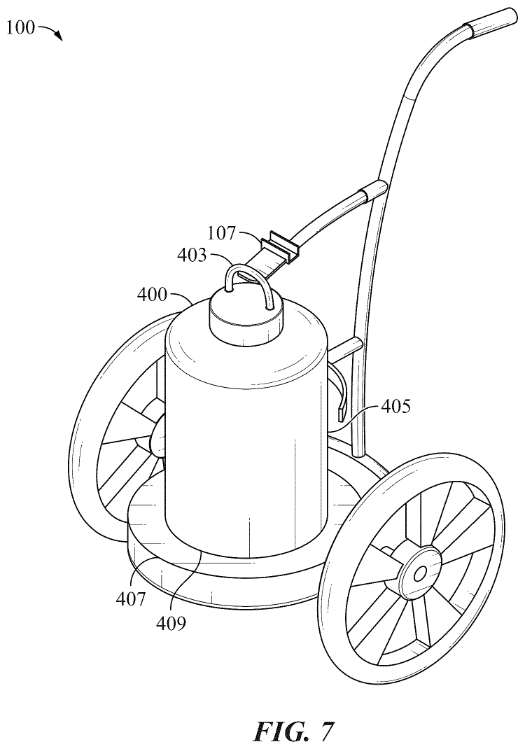

Referring to FIGS. 7-9 the poultry waterer 400 comprises a top lid 401 with a carrying handle 403, a center vessel 405, and a trough 407 at the bottom 409 of the center vessel 405. When using the device 100, to transport a filled poultry waterer 400, the poultry waterer 400 will be hung by the carrying handle 403 on the hook 107 of the device 100. The poultry waterer 400 will hang down from the hook 107 into the space between the wheels created by the arc-shaped axle. The center of gravity is designed to be over or slightly forward of the axles to allow for perfect balance and effortless motion during transportation.

The open bottom, hanging design of the device 100 allows the device to accommodate a variety of sizes and shapes of poultry waterers. The hook system along with the open bottom allow for the poultry waterer to swing by its carrying handle, allowing for travel over uneven surfaces without jostling and spilling the open contents. The device 100 can easily transport an otherwise heavy amount of material and be manipulated with one hand.

The poultry waterers 400 can be loaded onto the device 100 by tilting the device forward to slip the hook into the handle and tilted back by the handle. The poultry waterers can be unloaded from the device using the same motion in reverse.

In some embodiments, the device may be provided with various hook configurations such that the user can remove and replace the hook depending on the particular container being carried and transported. In such, the hook may be removably attached to the adjustable support arms.

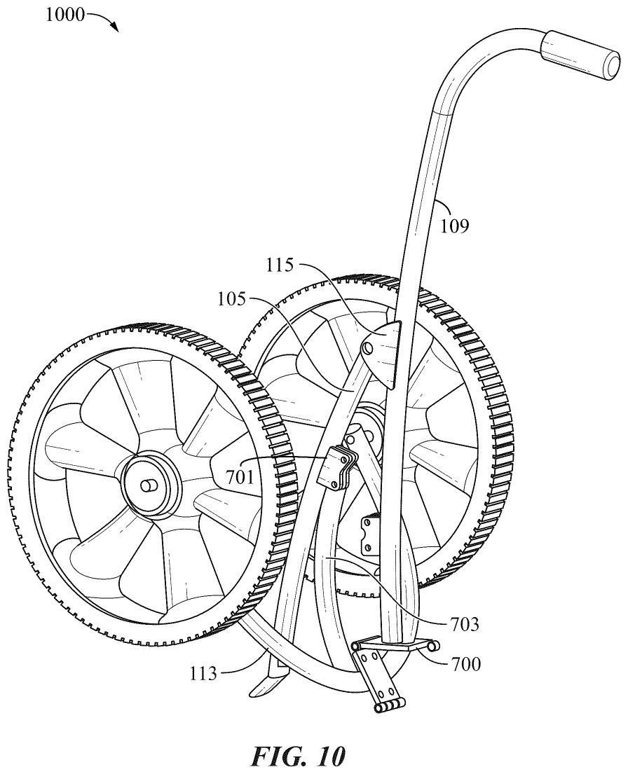

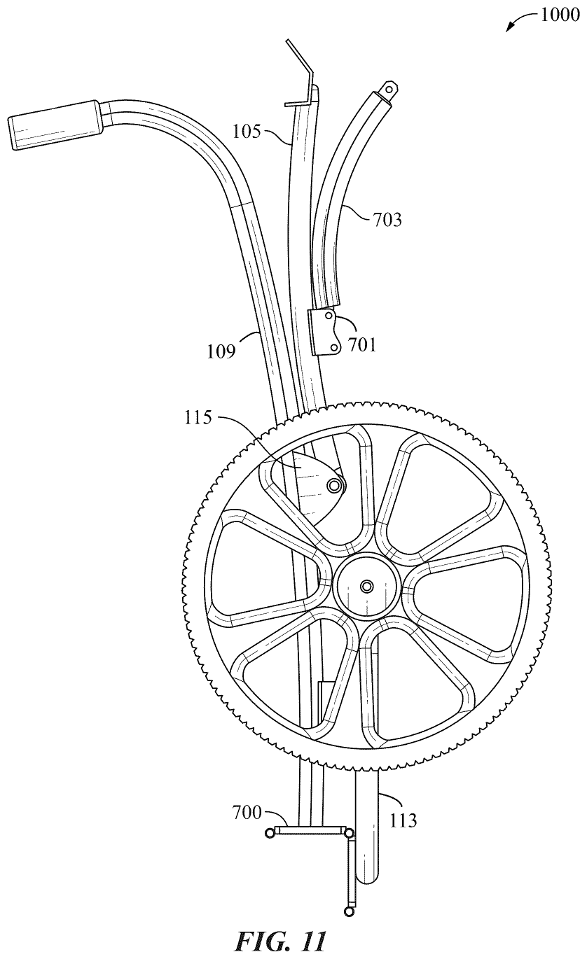

FIGS. 10 and 11 illustrate a perspective view of the container transportation device in a folded configuration 1000. FIG. 10 illustrates the first step of the folding process wherein the mounting bracket 700 pivots such that the lower frame assembly 113 folds towards the vertical spine 109. FIG. 11 shows the second step of the folding process wherein the pivot bracket 701 and bracket 115 are pivoted to fold the support arm 703 and lifting arm 105 to be arranged substantially parallel to the vertical spine 109.

It would be appreciated by those skilled in the art that various changes and modifications can be made to the illustrated embodiments without departing from the spirit of the present invention. While intended for the transportation of poultry waterers, the device can alternatively be used to transport other materials as well, such as poultry feed in buckets. All such modifications and changes are intended to be covered by the appended claims.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A container transportation device, comprising:
a lower frame assembly including an arc-shaped bar positioned between a first axle and a second axle;
a first wheel mounted to the first axle and a second wheel mounted to the second axle;
an upper frame including a vertical spine connected to the lower frame assembly at a base of the upper frame, the vertical spine extending between the base and a handle positioned at a top of the vertical spine;
a lifting arm extending from the vertical spine, wherein the lifting arm receives and supports a container to enable the transportation of the container.

2. The container transportation device of claim 1, further comprising a swing backstop to prevent the container from excessively swinging.

3. The container transportation device of claim 2, wherein the swing backstop is connected to the upper frame via a lateral member to extend the swing backstop in front of the upper frame.

4. The container transportation device of claim 1, wherein the device is foldable to allow the device to lie flat for storage or shipping.

5. The container transportation device of claim 1, further comprising a grip removably engaged with the handle.

6. The container transportation device of claim 1, wherein a top of the upper frame includes a curved portion to increase leverage.

7. The container transportation device of claim 1, wherein the lifting arm includes a hook positioned at an end of the lifting arm, wherein the hook retains a carrying handle of the container.

8. The container transportation device of claim 7, wherein the hook enables the container to hang from the carrying handle and pivot to facilitate the pick-up, transport, and set down of the container.

9. A container transportation cart, comprising:
a lower frame assembly including an arc-shaped bar positioned between a first axle and a second axle;
a first wheel mounted to the first axle and a second wheel mounted to the second axle;
an upper frame including a vertical spine connected to the lower frame assembly at a base of the upper frame, the vertical spine extending between the base and a handle positioned at a top of the vertical spine;
an adjustable lifting arm extending from the vertical spine, wherein the adjustable lifting arm includes a hook at an end, the hook to hold a carrying handle of a container, wherein the lifting arm is held in position by a support arm capable of being arranged in various positions.

10. The container transportation device of claim 9, wherein the hook is removable from the adjustable lifting arm.

11. The container transportation device of claim 10, wherein the device is configurable in a collapsible configuration to enable a user to enable the efficient transportation of the device.

12. The container transportation device of claim 11, further comprising a grip removably engaged with the handle.

13. The container transportation device of claim 12, wherein a top of the upper frame includes a curved portion to increase leverage to enable a user to easily tilt the device.

14. The container transportation device of claim 13, wherein the hook enables the poultry waterer to hang from the carrying handle and pivot to facilitate the pick-up, transport, and set down of the container.

15. The container transportation device of claim 14, wherein the device is configured for use as a poultry waterer transportation cart, wherein the poultry waterer is comprised of a lid, a center vessel, and a trough, wherein the center vessel contains a fluid.

16. A poultry waterer transportation device, comprising:
a lower frame assembly including an arc-shaped bar positioned between a first axle and a second axle;
a first wheel mounted to the first axle and a second wheel mounted to the second axle;
an upper frame including a vertical spine connected to the lower frame assembly at a base of the upper frame, the vertical spine extending between the base and a handle positioned at a top of the vertical spine;
a curved portion positioned at a top of the vertical spine to increase leverage when manipulating the handle;
an adjustable lifting arm extending from the vertical spine, wherein the adjustable lifting arm includes a hook at an end, the hook to hold a carrying handle of a poultry waterer;
a support arm connecting the lifting arm to the vertical spine,
wherein the poultry waterer transportation device is configured to be readily assembled for use and disassembled for storage.

17. The poultry waterer transportation device of claim 16, wherein the hook allows the poultry waterer to pivot thereon to enable container to be placed on the ground and released from the device.

18. The poultry waterer transportation device of claim 17, further comprising an adjustable support arm adjustably mounted between the vertical spine and the adjustable lifting arm.

19. The poultry waterer transportation device of claim 18, wherein the adjustable lifting arm enables the adjustment of the height of the lifting arm.

20. The poultry waterer transportation device of claim 19, wherein the adjustable support arm is connected, via a pivot bracket on the vertical spine and at an opposite end by a pivot bracket on a bottom of the lifting arm, wherein the pivot brackets have multiple positions allowing the height of the lifting arm to be determined by the position of the adjustable support arm.
